(19) United States
(12) Patent Application Publication
(10) Pub. No.: US 2005/0096029 A1
(43) Pub. Date: May 5, 2005

(54) Method and system for call forwarding in multimedia telecommunication networks

(75) Inventors: Mariana Benitez Pelaez, Naperville, IL (US); Victoria Marie Halsell, Aurora, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114, US

(73) Assignee: Lucent Technologies Inc.

(21) Appl. No.: 10/696,129

(22) Filed: Oct. 29, 2003

(51) Int. Cl. H04M 3/00

(52) U.S. Cl. 455/419

(57) ABSTRACT

A method of forwarding calls for a subscriber having a primary communication device and a number of alternate communication devices in a multimedia telecommunication network by storing a call forwarding profile for the subscriber's primary communication device at a network server, where the call forwarding profile specifies at least one of the alternate communication devices to which specific types of calls are to be forwarded based on the incoming media desired for that call, receiving a call for the subscriber's primary communication device from a caller, determining the type of the call that has been received, matching the type of call received to the call forwarding profile, and routing the call to the proper alternate communication device according to the call forwarding profile.

### FIELD OF THE INVENTION

The present invention relates generally to the art of telecommunication, and, more particularly, to a method and system for call forwarding in a multimedia telecommunication network.

### BACKGROUND OF THE INVENTION

Wireless telecommunication networks allow mobile devices to communicate with each other and other networks, such as the Internet and the public switched telephone network. First and second generation wireless telephone systems are generally constrained in the amount of bandwidth available for communication. This limits capacity and also the types of services that can be provided. Third generation wireless systems, which are being developed through the 3rd Generation Partnership Project (3GPP), hold the promise of greater bandwidth, thereby increasing capacity and allowing for enhanced services, such as multimedia services. 3GPP is the new worldwide standard for the creation, delivery, and playback of multimedia over new, high-speed wireless networks. 3GPP enables the free sharing of multimedia files between a variety of devices, including cell phones, PDAs, and desktop computers. 3GPP devices include, in addition to a voice communication interface, capability for communication of data and display of data, including video.

Certain features are currently available to telephone service subscribers, including wireless subscribers. For example, select call forwarding is a service that automatically forwards calls from a selected set of numbers to a phone number of the subscriber's choice. Call forwarding services may also allow the subscriber to decide which calls to receive. Typically, incoming calls to the subscriber's phone from the numbers preselected are rerouted to a phone number of the subscriber's choice, whether it's the subscriber's mobile, office, or other number. When call forwarding is activated, the subscriber's home phone may ring once with a short burst as a reminder that the call is being transferred. Further, busy call forwarding is a service that automatically forwards calls to another number when the subscriber's line is busy. Busy call forwarding eliminates missing a call when the line is in use. Typically, incoming calls to the subscriber's busy line are rerouted to a phone number of the subscriber's choice, whether it's the subscriber's mobile, office, or other number.

There is a need for a method and system that would allow a subscriber to send forward calls to multiple numbers, based upon the type of data being sent or other provisioned settings. Also, it is desirable to have a method and system in which a call may be forwarded to different destinations based on the type of data.

### SUMMARY OF THE INVENTION

In accordance with one aspect of the invention, a method for method of forwarding calls for a subscriber having a primary communication device and a number of alternate communication devices in a multimedia telecommunication network is provided. The method includes storing a call forwarding profile for the subscriber's primary communication device in a network server, where the call forwarding profile specifies at least one of the alternate communication devices to which specific types of calls are to be forwarded, receiving a call for the subscriber's primary communication device from a caller, determining the type of the call that has been received, matching the type of call received to the call forwarding profile, and routing the call to the proper alternate communication device according to the call forwarding profile.

In accordance with another aspect of the invention, a system for forwarding calls for a subscriber having a primary communication device and a plurality of alternate communication devices in a multimedia telecommunication network is provided. The system includes means for storing a call forwarding profile for the subscriber's primary communication device at a network server, where the call forwarding profile specifies at least one of the alternate communication devices to which specific types of calls are to be forwarded, means for receiving a call for the subscriber's primary communication device from a caller, means for determining the type of the call that has been received, means for matching the type of call received to the call forwarding profile, and means for routing the call to the proper alternate communication device according to the call forwarding profile.

Still further advantages and benefits of the present invention will become apparent to those of ordinary skill in the art upon reading and understanding the present specification.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a block diagram showing a known multimedia telecommunication environment suitable for implementing aspects of the present invention.

FIG. 2 is a flow chart illustrating a call forwarding process in accordance with an aspect of the present invention.

FIG. 3 is memory layout of data stored in the centralized database in accordance with an aspect of the present invention.

### DETAILED DESCRIPTION OF THE INVENTION

It is to be understood that the specific methods and systems illustrated in the attached drawings and described in the following specification are simply exemplary embodiments of the inventive concepts defined in the appended claims. Therefore, specific examples and characteristics related to the embodiments disclosed herein are not to be considered as limiting, unless the claims expressly state otherwise.

For simplicity and ease of reference, the acronyms listed below shall be used in the specification to refer to structural and/or functional network elements, relevant telecommunication standards, protocols and/or services, terminology, etc., as they are commonly known in the telecommunication art, except to the extent they have been modified in accordance with aspects of the present invention.

3G—3^{rd} Generation

3GPP—3^{rd} Generation Partnership Project

3GPP2—3^{rd} Generation Partnership Project 2

AAA—Authentication/Authorization/Accounting

AH—Address Handling

AS—Application Server

BGCF—Border Gateway Control Function

CCF—Call Control Function

CDMA—Code Division Multiple Access

CSCF—Call Session Control Function

HLR—Home Location Register

HSS—Home Subscriber Server

ICGW—Incoming Call Gateway

IMS—IP Multimedia Subsystem

IP—Internet Protocol

MGCF—Media Gateway Control Function

MGW—Media Gateway

MMT—Multimedia Terminal

MRFC—Multimedia Resource Function Controller

MRFP—Multimedia Resource Function Processor

PDN—Public Data Network

PLMN—Public Land Mobile Network

PSDN—Packet Switched Data Network

PSTN—Public Switched Telephone Network

PTT—Push-to-Talk

RAN—Radio Access Network

SIP—Session Initiation Protocol

SMS—Short Message Service

SMT—Single Media Terminal

SPD—Serving Profile Database

UMTS—Universal Mobile Telecommunications System

VoIP—Voice over IP

WLAN—Wireless Local Area Network

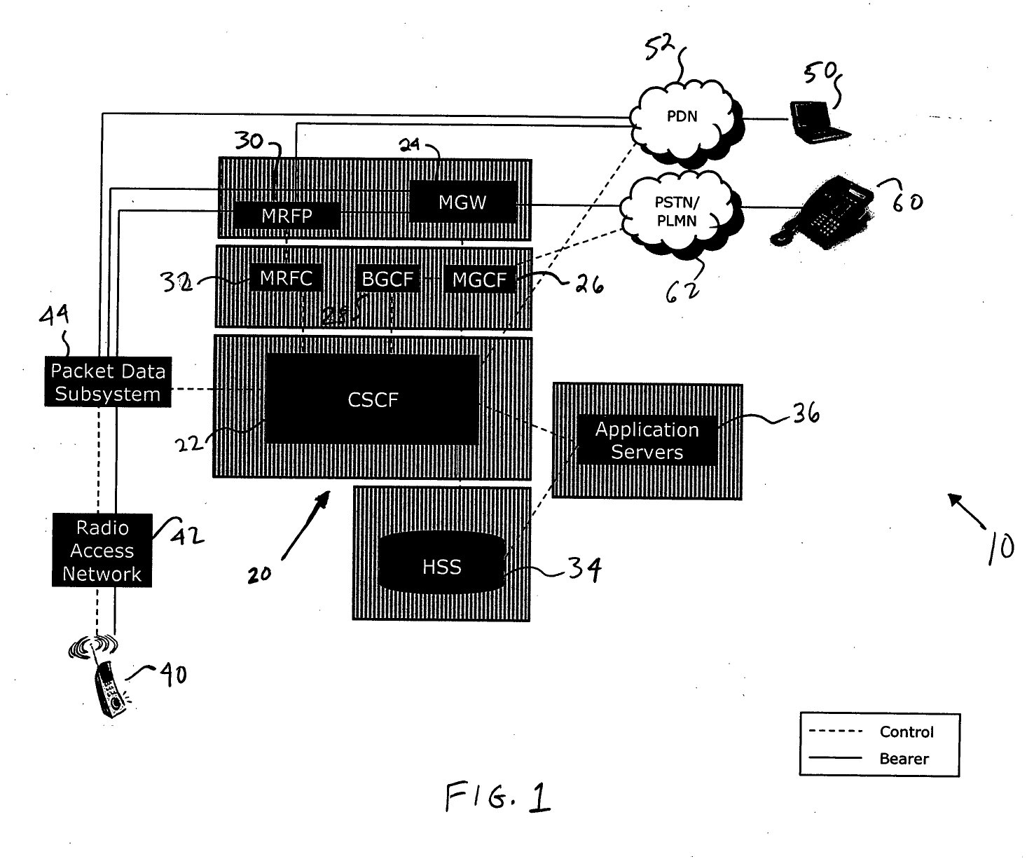

FIG. 1 is a block diagram of a known multimedia telecommunication network 10 suitable for implementation of aspects of the present invention. However, it is to be understood that other such networks may also be suitable. The multimedia telecommunication network 10 provides users with a variety of options for communication. Users are able to transmit and receive multimedia communications, including audio, voice, video, and all types of data. The multimedia telecommunication network 10 provides access to data networks, such as the Internet, and public telephone networks, including wireless networks.

The multimedia telecommunication network 10 preferably includes an IP multimedia subsystem (IMS) 20. The IMS 20 relates to a technology standardized by the 3^{rd} Generation Partnership Project, also known as 3GPP, and it is also defined by 3GPP2 (3^{rd} Generation Partnership Project 2). The IMS 20 is used to join mobile communication with IP technologies by adding the ability to deliver integrated voice and data services over the IP-based packet switched network. IMS services are based on the Session Initiation Protocol (SIP), which is the signaling protocol standard for next-generation 3GPP mobile wireless networks. The IMS 20 includes a number of system elements, such as a call session control function (CSCF) 22, media gateways (MGW) 24, a media gateway control function (MGCF) 26, a border gateway control function (BGCF) 28, a multimedia resource function processor (MRFP) 30, a multimedia resource function controller (MRFC) 32, a home subscriber system (HSS) 34 and application servers 36. As is known in the art, the IMS 20 manages call sessions and provides and administers packet switching for multimedia communications within the network 10.

A first communication device 40 is shown in FIG. 1. The first communication device 40 may be a wireless device that includes a user interface and an interface for coupling to a radio access network (RAN) 42. The user interface of the communication device 40 is typically referred to as terminal equipment and generally includes an audio interface, such as a microphone and speakers, a visual interface, such as a display, and a user input interface, such as a keyboard or touch pad. The interface for coupling to the RAN 42 is typically referred to as a mobile terminal and generally includes an over-the-air interface for transmitting and receiving data. The over-the-air interface of communication device 40 is used to communicate with base stations in the RAN 42. Preferably, the communication device 40 and the base stations in the RAN 42 communicate over-the-air using a packet-based protocol. A packet data subsystem (PDS) 44 couples the RAN 42 with the IMS 20 and the public data network (PDN) 52 in the usual manner.

A second communication device 50 is shown as a laptop or notebook computer operatively connected to the IMS 20 via the PDN 52. The communication device 50 optionally employs a wireless local area network (WLAN) or wireline network, in the usual manner, to operatively connect to the PDN 52. A third communication device 60 is shown as an ordinary telephone equipped to handle only voice communications. The communication device 60 is operatively connected to the IMS 20 via the public switched telephone network/public land mobile network (PSTN/PLMN) 62.

Only three communication devices (40, 50, and 60) are shown in FIG. 1 for the purpose of simplifying the diagram. However, it is to be appreciated that any number of such terminals are typically situated in the multimedia telecommunication network 10. Additionally, while each is depicted as a specific type of communication device, other like terminals may also be incorporated.

With continuing reference to FIG. 1, the bearer paths that carry (or relay) the communication traffic and/or user information for transmission from one terminal to another, which are known in the art, are shown as solid lines. Control paths carry associated signaling and/or control commands (or messages) to and between appropriate network elements for the purpose of managing and routing call sessions. The control paths are shown as dashed lines in FIG. 1. Suitably, SIP and other known protocols are used on the control and bearer paths, respectively. For example, the known H.248 protocol is suitably employed for media gateway control. The CSCF 22, the BGCF 28, the MGCF 26, the MRFC 32 and the AS 36 comprise the call control and signaling functionality for the IMS 20, while the bearer paths interface with the MRFP 30 and the MGW 24 to provide and support interconnectivity to external networks and/or subsystems, such as the PDS 44, the PDN 52 and the PSTN/PLMN 62.

The CSCF 22 supports and controls multimedia sessions. The CSCF 22 invites elements such as the MGCF 26 and the MRFC 32 to call sessions to control the establishment and maintenance of bearer paths for call sessions by adding, modifying or deleting appropriate bearer paths for respective call sessions. The CSCF 22 is the signaling entity for call session control. It manages sessions by using SIP and/or other appropriate call/session establishment protocols, and it provides features and services and coordinates with other network elements for session control, service control and resource allocation.

The CSCF 22 may provide the following functionalities: incoming call gateway, call control function, serving profile database, and address handling. By functioning as an incoming call gateway the CSCF 22 acts as a call session entry point and routes incoming calls. The call control function generally refers to call setup/termination and state/event management. The CSCF 22 interacts with the MGCF 26 for calls to/from the PSTN/PLMN 62 and with the BGCF 28 for calls to the PSTN/PLMN 62 to determine the appropriate MGCF 26 to use. It also controls the MRFP 30 via the MRFC 32, which interprets information or signals coming from the CSCF 22 and controls the MFRP 30, in order to support conferencing and other multi-party services. SIP level registrations from subscribers are processed with the call control function. The call control function may also provide service trigger mechanisms to the application servers 24 to invoke services provided thereby, either locally, at the application servers 24, or elsewhere. It also reports call events for billing, auditing, intercept or other purposes, and may query the address handling function to check whether a requested communication is allowed given the current subscription. The serving profiling database function refers to the interaction of the CSCF 22 with the HSS 34 to receive and cache user profile information. The address handling function refers to address analysis, translation, modification (when appropriate) and mapping.

The MGW 24 acts as a bearer path interface between the IMS 20 and externals networks and/or subsystems, and provides translation resources and resources for modifying the bearer stream (e.g., encoding, transcoding, compression, packetization, depacketization, etc.). The bearer path elements include the MGCF 26, the MRFC 32, and the BGCF 28. These elements provide the flexibility to add, modify or delete bearers used by the users' services. More particularly, the MGW 24 interacts with the MGCF 26, which interprets signaling coming from the CSCF 22 and controls the MGW 24 to achieve resource allocation, bearer path control, and payload processing. The MGCF 26 communicates with the CSCF 22 in order to control the call state for media channels on one or more MGWs and performs conversions between Legacy and 3^{rd} Generation (3G) Universal Mobile Telecommunications System (UMTS)/Code Division Multiple Access (CDMA) network call control protocols. Similarly, the MRFC 32 controls the media stream resources in the MRFP 30, which also acts as a bearer path interface between the IMS 20 and external networks and/or subsystems, while being able to provide for conferencing or multiple party communications or other more advanced media services (relative to the MGW 24). The BGCF 28 selects the proper MGCF 26.

The HSS 34 is coupled to the CSCF 22 via a data link. The HSS 34 includes subscriber profile information, including information traditionally associated with a home location register (HLR) for a mobile subscriber. Suitably, the HSS 34 stores information such as user identification, user security information, including network access control information for authentication and authorization, user location information for user registration and locating, and user profiles, including identification of the services subscribed to and other service specific information.

The application servers 36 are preferably coupled to the IMS 20 for use in interaction with the communication devices 40, 50, 60. In particular, the CSCF 22 is coupled to the application servers 36 via a data link. Also, the HSS 34 is preferably coupled to the application servers 36. A myriad of services and applications may reside in or be coupled to the application servers 36, including a call forwarding method and system in accordance with the present invention.

In the preferred embodiment, the CSCF 22, the MGCF 26, the MGW 24, the HSS 34, and the application servers 36 are processor-based apparatus with data link interfaces for coupling together as described above and shown in FIG. 1. These apparatus include one or more processors that execute programs to implement the functionality described herein and generally associated with 3GPP/3GPP2 wireless systems. The flexibility of these processor-based systems permits ready integration into these systems of a multimedia call forwarding method and system in accordance with the present invention.

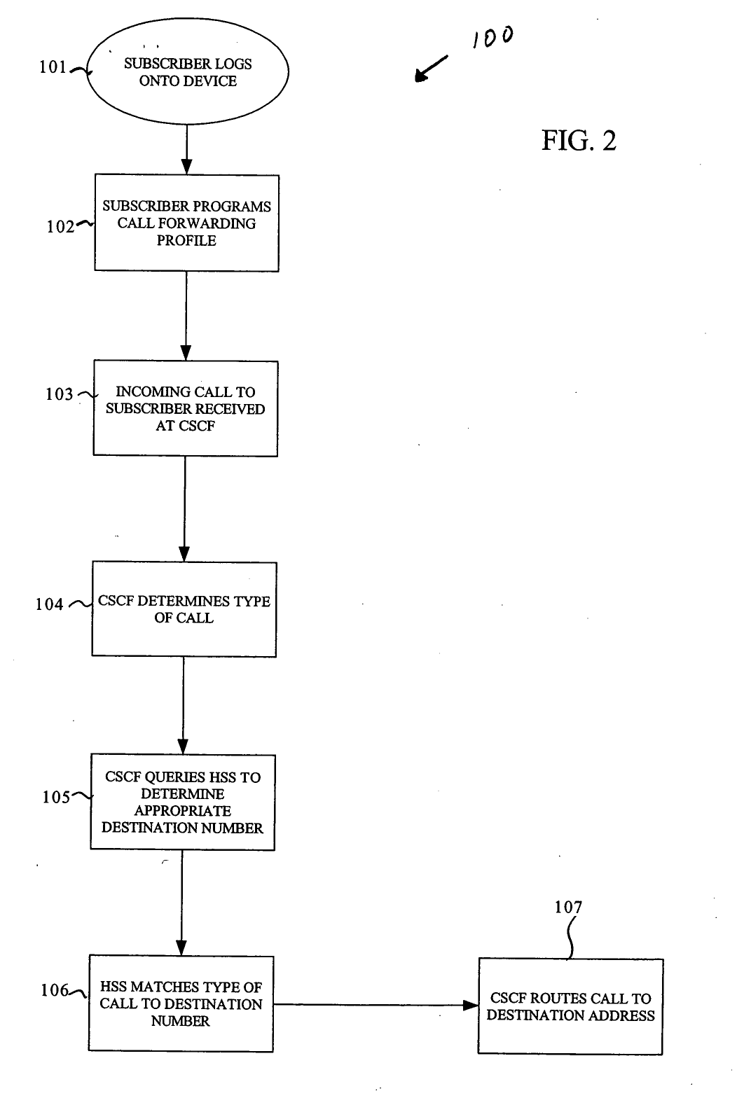

In accordance with a preferred embodiment of the present invention, FIG. 2 shows a method 100 of forwarding multimedia calls to multiple destination numbers, based upon the type of data being sent or other provisioned settings. FIG. 2 is described below with reference to the network 10 of FIG. 1, although the method 100 may be implemented in other compatible multimedia networks.

Initially, in step 101, a wireless subscriber logs on to the first communication device 40, which preferably supports wireless voice and data transmission as well as data push services (DPS) such as Instant Messaging (IM), which allows users to send messages to any of the people in their pre-selected contact list as long as that person is online, Short Message Service (SMS), which enables the transmission of alphanumeric messages between mobile subscribers and external systems such as electronic mail, paging, and voice-mail systems, and Multimedia Messaging Service (MMS), which integrates the composition, storage, access and delivery of different kinds of media, e.g., text, voice, image, animations, music or video.

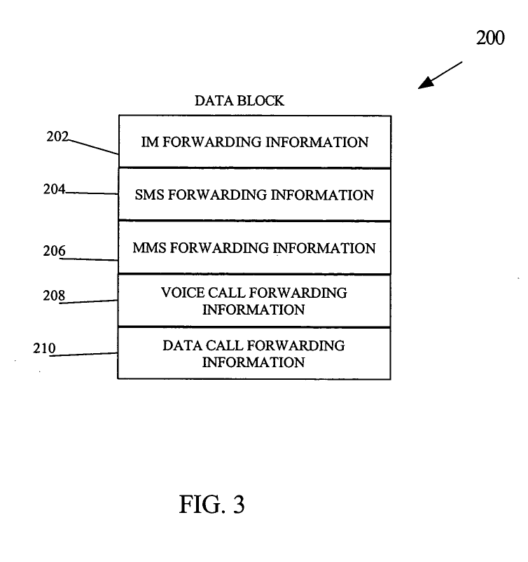

Next, because the subscriber needs to leave his or her present location and communication device, the subscriber sets up a call forwarding profile, which is stored in a centralized database, such as at the HSS 34 or at an AS 36. (step 102). The centralized database includes a number of data sub-blocks for each subscriber. These are shown in FIG. 3. They are shown as a super block 200, not all of whose fields are filled for a particular subscriber. The super block, as known in the art, can be accessed from the identity of any one of several fields in the super block.

The super block 200 includes the following data sub-blocks: block 202 contains the subscriber's IM forwarding information; block 204 contains the subscriber's SMS forwarding information; block 206 contains the subscriber's MMS forwarding information, block 208 contains the subscriber's voice call forwarding information, and block 210 contains the subscriber's data call forwarding information. Of course, additional blocks may be provided in the super block 200 for storing additional subscriber data.

The call forwarding profile may be programmed in various ways, including through the subscriber's communication device 40 via an automated service or by entering a feature activation code (e.g., *78), by logging on to the service provider's Internet Web site, or by calling a call center. The subscriber will generally want to forward the type of communication/media to the most convenient device available. Thus, the subscriber may want to submit a call forwarding profile along the lines of the following:
Forward all IMs to the second communication device 50 (e.g., this could be a mobile phone)
Forward all SMSs to the second communication device 50 (e.g., this could be the same mobile phone)
Forward all MMSs to the third communication device 60 (e.g., this could be a mobile phone with MMS capabilities or a laptop computer)
Forward all other calls (e.g., voice and data) to the second communication device 50 (e.g., this could be the same mobile phone as above)
   Of course, it is to be understood that other call forwarding profiles may be programmed, depending upon the devices and services available to the subscriber.

In step 103, an incoming call having a unique destination address is received at the CSCF 22 in the traditional manner. Next, the CSCF 22 determines the type of call based upon media parameters that are contained in the incoming call request (e.g. ISUP (ISDN User Part) IAM (Initial Address Message) or SIP INVITE) (step 104). These would indicate the “type of call,” be it data, text, voice, etc. via existing media description parameters. The CSCF 22 then queries the HSS 34 to determine the appropriate destination number (i.e., the appropriate communication device) for the call (step 105) based on the type of media identified in the incoming call request. The HSS 34 looks up the call forwarding information for the unique destination address and media type and returns this information to the CSCF 22 (step 106). The CSCF 22 routes the call to the appropriate destination address (step 107).

The invention has been described with reference to the preferred embodiments. Obviously, modifications and alterations will occur to others upon reading and understanding the preceding detailed description of the preferred embodiments. It is intended that the invention be construed as including all such modifications and alterations insofar as they come within the scope of the appended claims or the equivalence thereof.

1. A method of forwarding calls for a subscriber having a primary communication device and a plurality of alternate communication devices in a multimedia telecommunication network, the method comprising:
storing a call forwarding profile for the subscriber's primary communication device at a network server, the call forwarding profile specifying at least one of the alternate communication devices to which specific types of calls, based on the incoming media, are to be forwarded;
receiving a call for the subscriber's primary communication device from a caller;
determining the type of the call that has been received;
matching the type of call received to the call forwarding profile; and
routing the call to the proper alternate user device according to the call forwarding profile.

2. The method defined in claim 1, wherein the call comprises an instant message, a short message service, a multimedia message service, a voice call, or a data call.

3. The method defined in claim 1, wherein the multimedia telecommunication network includes an IP multimedia subsystem.

4. The method defined in claim 3, wherein the network server comprises a home subscriber server in the IP multimedia subsystem.

5. The method defined in claim 3, wherein the network server comprises an application server in the IP multimedia subsystem.

6. The method defined in claim 1, wherein the primary communication device comprises a mobile phone, a personal digital assistant, a notebook computer, or a desktop computer with multimedia communication capabilities.

7. The method defined in claim 1, wherein the call forwarding profile is programmed by the subscriber via an automated service, by entering a feature activation code, through the Internet (World Wide Web), or by calling a call center.

8. A system for forwarding calls for a subscriber having a primary communication device and a plurality of alternate communication devices in a multimedia telecommunication network, the system comprising:
means for storing a call forwarding profile for the subscriber's primary communication device at a network server, the call forwarding profile specifying at least one of the alternate communication devices to which specific types of calls are to be forwarded;
means for receiving a call for the subscriber's primary communication device from a caller;
means for determining the type of the call that has been received;
means for matching the type of call received to the call forwarding profile; and
means for routing the call to the proper alternate communication device according to the call forwarding profile.

9. The system defined in claim 8, wherein the call comprises an instant message, a short message service, a multimedia message service, a voice call, or a data call.

10. The system defined in claim 8, wherein the multimedia telecommunication network includes an IP multimedia subsystem.

11. The system defined in claim 10, wherein the network server comprises a home subscriber server in the IP multimedia subsystem.

12. The system defined in claim 10, wherein the network server comprises an application server in the IP multimedia subsystem.

13. The system defined in claim 8, wherein the primary communication device comprises a mobile phone, a personal digital assistant, a notebook computer, or a desktop computer with multimedia communication capabilities.

14. The system defined in claim 8, wherein the call forwarding profile is programmed by the subscriber via an automated service, by entering a feature activation code, or through the Internet.

15. In a multimedia telecommunication system, apparatus for forwarding calls for a subscriber having a primary communication device and a plurality of alternate communication devices, comprising:
a centralized database adapted to store a call forwarding profile for the subscriber's primary communication device, the call forwarding profile specifying at least one of the alternate communication devices to which specific types of calls are to be forwarded; and
a call session control function adapted to receive a call for the subscriber's primary communication device from a caller, determine the type of the call that has been received, and route the call to the proper alternate communication device according to the call forwarding profile.

16. The apparatus defined in claim 15, wherein the call comprises an instant message, a short message service, a multimedia message service, a voice call, or a data call.

17. The apparatus defined in claim 15, wherein the multimedia telecommunication system comprises an IP multimedia subsystem.

18. The apparatus defined in claim 17, wherein the centralized database comprises a home subscriber server.

19. The system defined in claim 17, wherein the network server comprises an application server in the IP multimedia subsystem.

20. The system defined in claim 15, wherein the primary communication device comprises a mobile phone, a personal digital assistant, a notebook computer, or a desktop computer with multimedia communication capabilities.
